(19) United States
(12) Patent Application Publication
(10) Pub. No.: US 2021/0004736 A1
(43) Pub. Date: Jan. 7, 2021

(54) TASK MODIFICATION AND OPTIMIZATION

(71) Applicant: Microsoft Technology Licensing, LLC, Redmond, WA (US)

(72) Inventors: Elnaz NOURI, Redmond, WA (US); Mark J. ENCARNACION, Bellevue, WA (US); Michael GAMON, Seattle, WA (US); Ryen W. WHITE, Woodinville, WA (US)

(73) Assignee: Microsoft Technology Licensing, LLC, Redmond, WA (US)

(21) Appl. No.: 16/503,001

(22) Filed: Jul. 3, 2019

(51) Int. Cl. G06Q 10/06; G06F 9/54; G06F 3/0482

(52) U.S. Cl. CPC G06Q 10/0631; G06F 3/0482; G06F 9/542

(57) ABSTRACT

Aspects of the present disclosure relate to task modification and optimization. In examples, a user provides an indication of a task goal. A set of candidate task templates are identified based on the task goal. The user specifies optimization criteria, and the set of candidate task templates is ranked based on the optimization criteria. Accordingly, at least a part of the ranked set is presented to the user, from which the user selects a task template. In other examples, an optimal task template is determined automatically. In some instances, a user selects a subtask of an existing task to optimize in view of optimization criteria. Accordingly, a set of candidate subtasks is identified. The set of candidate subtasks is ranked according to the optimization criteria, after which a user may select one or more replacement subtasks. As a result, subtasks of the task are replaced according to the selected subtask.

### BACKGROUND

A task management application enables users to track various tasks. A user may prefer to complete a task in any of a variety of different ways in view of one or more constraints. However, determining the optimal way to complete a task in view of such constraints is difficult, especially when considering multiple constraints.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to task modification and optimization. In examples, a user provides an indication of a task goal. A set of candidate task templates are identified based on the task goal, wherein each of the candidate task templates comprise a set of subtasks to achieve the task goal. The user also specifies optimization criteria, such that the set of candidate task templates is ranked based on the optimization criteria. Accordingly, at least a part of the ranked set is presented to the user and the user selects a task template from which a task is generated in a task management application. In other examples, an optimal task template is determined automatically and used to generate a task for the user.

In some instances, a user selects a subtask of an existing task to optimize in view of optimization criteria. Accordingly, a set of candidate replacement subtasks is identified. The set of candidate replacement subtasks is ranked according to the optimization criteria, after which a user may select one or more replacement subtasks. As a result, one or more subtasks of the task are replaced according to the selected subtask(s). Thus, the user is able to alter a task in response to changed constraints while still maintaining the same end task goal.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system for task modification and optimization.

FIG. 2A illustrates an overview of an example method for optimizing a task in response to an optimization request.

FIG. 2B illustrates an overview of an example method for optimizing a subtask in response to an optimization request.

FIG. 3A illustrates an overview of an example method for generating a task in a task management application based on optimization criteria.

FIG. 3B illustrates an overview of an example method for optimizing a subtask based on optimization criteria.

FIGS. 4A-4D illustrate overviews of example user interface features for task modification and optimization.

FIG. 5 is a block diagram illustrating example physical components of a computing device with which aspects of the disclosure may be practiced.

FIGS. 6A and 6B are simplified block diagrams of a mobile computing device with which aspects of the present disclosure may be practiced.

FIG. 7 is a simplified block diagram of a distributed computing system in which aspects of the present disclosure may be practiced.

FIG. 8 illustrates a tablet computing device for executing one or more aspects of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

A task management application provides functionality that enables a user to manage and track a task to completion. For example, a task may be comprised of a set of subtasks, have one or more associated resources, and/or have other users with which aspects of the task are associated. Thus, it is possible to view progress toward completion of the task, generate an estimated time of completion, and delegate aspects of the task to other users. However, in some examples, the same task goal may be completed by performing any of a variety of different sets of subtasks. For example, each set may comprise at least a partially different group of subtasks or subtasks in a different order, while still ultimately achieving the task goal. Depending on a user's circumstances, one set of subtasks may be favorable as compared to another set of subtasks. As an example, different sets may have different associated monetary costs and/or time requirements, among other costs. In other examples, a user may wish to substitute a subtask of an existing task with one or more other subtasks in order to better suit the circumstances of the user. However, identifying such alternatives and deciding between them is difficult, especially in instances where multiple constraints are to be considered.

Accordingly, aspects of the present disclosure relate to task modification and optimization. In examples, a user provides a task goal, which indicates a desired end result or goal to achieve (e.g., fixing a grill, preparing a meal, planning a trip, etc.). In some examples, a user provides information regarding an initial state, such as available inputs, a current location, available time to complete the task, a budget for the task, etc. Accordingly, a set of candidate task templates relating to the task goal are identified. For example, task templates may be accessed from a task template catalog comprising automatically generated task templates (e.g., from a data source such as a website, a how-to video, etc.) and/or user-submitted task templates (as may be shared or accessed from a task catalog, etc.). In examples, the candidate templates are ranked, such that the user may view at least a subset of the ranked candidate task templates to manually select a task template accordingly. In other examples, the set of candidate templates comprises a single task template or a task template is automatically determined from the set of candidate templates.

Thus, a set of subtasks to complete a task goal that is “optimal” depending on a user's circumstances is generated. As used herein, optimal refers to a task, subtask, or set of subtasks having one or more improved characteristics as compared to at least one other task, subtask, or sets of subtask. For example, an optimized or optimal task may exhibit a reduced estimated time required for completion, a reduced monetary cost, or an increased estimated likelihood of success, among other examples. As a result of the aspects disclosed herein, the utility of the task management application is increased because the user is more likely to use the task management application to manage the task as a result of being able to automatically optimize tasks. Additionally, processing the task catalog to identify crowd-sourced and automatically generated task templates improves both the expediency and accuracy of identifying alternative tasks/subtasks. By contrast, the user would otherwise have to manually identify potential alternatives and/or improved subtasks based mainly on intuition and past experience.

A task may be comprised of one or more subtasks. In some examples, one subtask is dependent on one or more other subtasks, such that the other subtasks are prerequisites for completing the subtask. In other examples, subtasks are hierarchical, wherein a subtask is further comprised of a set of other constituent subtasks. A task may be associated with a resource, wherein the resource is relevant to completing the task. Example resources include, but are not limited to, a document, a link to a website, contact information, a set of tools, or audio or video content, among other examples. In another example, a task is associated with one or more users, which may be responsible for overseeing or performing aspects of the task. In examples, a task may have one or more associated “costs.” Example costs include, but are not limited to, an estimated or actual amount of time to complete the task, an estimated or actual monetary cost associated with the task, and/or one or more inputs to perform the task (e.g., ingredients, supplies, etc.). It will be appreciated that while examples are described herein with respect to a task, such examples are similarly applicable to subtasks.

As discussed above, a user may provide a task goal that indicates an outcome that the user intends to achieve as a result of performing a task. Thus, the task goal will be achieved as a result of the user performing the task, even though the associated subtasks to achieve the task goal will vary depending on the optimization techniques described herein. An initial state may also be determined. In examples, the initial state comprises information received from a user (e.g., in response to one or more prompts, previous user input, one or more user preference indications, etc.) and/or determined from one or more computing devices (e.g., a user's computing device, a remote computing device, etc.). For example, the initial state comprises information regarding available inputs, time constraints, budget constraints, and other information. Thus, the initial state represents the circumstances from which the user is starting and the task goal is the desired end state as a result of completing the task. In other examples, the initial state represents the current (or expected) circumstances of the user (e.g., as may be the case after some subtasks associated with a task have been performed). As such, it will be appreciated that while examples are described herein with respect to an “initial” state existing prior to performing a task, an initial state as used herein represents a state prior to achieving the task goal.

A user may specify one or more optimization criteria. Example criteria include, but are not limited to, a time constraint, a budget constraint, a dependency on the availability of another user, and/or a dependence on another task. In examples, a threshold is used while, in other examples, a user may indicate a criterion that more generally specifies an improvement (e.g., a “faster” or “cheaper” way to achieve the task goal). It will be appreciated that other criteria may be used, such as a criterion that reduces or minimizes the amount of effort required or increases or maximizes the likelihood of success.

A task template is used to generate a task. As described above, a task template may be accessed from a task template catalog and may be an automatically generated task template or may be a user-submitted task template, among other examples. Optimization criteria are used to rank a set of candidate task templates and/or determine an optimal task template based on the initial state and costs associated with each task template. In examples, one or more subtasks of a task template may be unordered, such that the order of the subtasks is automatically determined (e.g., based on an evaluation of one or more costs, the initial state, and/or optimization criteria, among other examples). Once a candidate task template is selected (e.g., by a user, automatically, etc.), the task template is used to generate a task in a task management application.

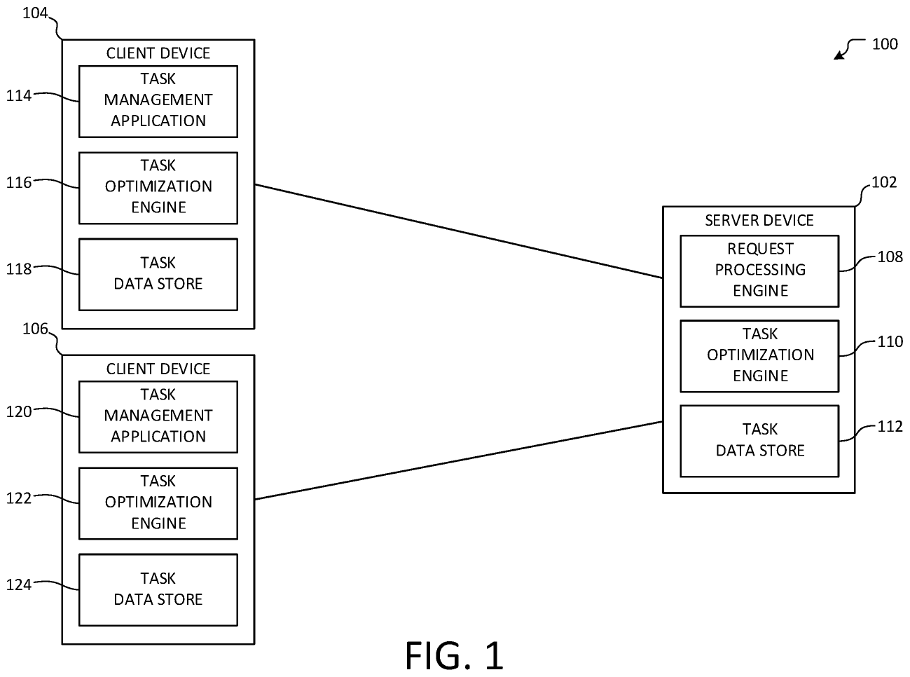

FIG. 1 illustrates an overview of an example system 100 for task modification and optimization. As illustrated, system 100 comprises server device 102, client device 104, and client device 106. In examples, server device 102, client device 104, and client device 106 communicate using a network, such as a local area network, a wireless network, or the Internet, or any combination thereof. In an example, client device 104 and client device 106 are any of a variety of computing devices, including, but not limited to, a mobile computing device, a laptop computing device, a tablet computing device, or a desktop computing device. In other examples, server device 102 is a computing device, including, but not limited to, a virtualized computing device, a desktop computing device, or a distributed computing device. It will be appreciated that while system 100 is illustrated as comprising one server device 102 and two client devices 104 and 106, any number of devices may be used in other examples.

Client device 104 is illustrated as comprising task management application 114, task optimization engine 116, and task data store 118. In examples, task management application 114 manages one or more task lists for a user of client device 104. As used herein, a task list comprises a set of tasks. In examples, the tasks are related and/or interdependent. According to aspects described herein, task management application 114 is used to determine optimized task for achieving a task goal according to one or more optimization criteria. In some instances, task management application 114 is used to replace a subtask with one or more other subtasks based on a user's optimization criteria. It will be appreciated that, in other instances, multiple subtasks may be replaced by a single subtask. In examples, a different application, such as a web browser or email application, is used to perform aspects described herein.

As illustrated, client device 104 further comprises task optimization engine 116. In examples, task optimization engine 116 receives an indication of a task goal (e.g., as may be received from a user by task management application 114) for which a task is to be determined. In examples, task optimization engine 116 determines an initial state. The initial state may be associated with the task goal. As described above, the initial state comprises information received from or associated with a user (e.g., available inputs, a time constraint, budget constraint, etc.). In some instances, such information is determined automatically (e.g., based on an analysis of a user's calendar, historical behavioral information, etc.). In another example, the initial state comprises information from one or more computing devices. For example, the initial state comprises a location of client device 104, a battery status, available software installed on client device 104, and/or hardware capabilities of client device 104, among other examples. As another example, information from another computing device is used, such as client device 106 and/or server device 102. While example initial state information is described herein, it will be appreciated that any of a variety of other initial state information may be used.

In some examples, task optimization engine 116 determines a set of candidate task templates associated with the task goal. The determination may comprise an analysis of the initial state to identify task templates associated with a similar initial state. For example, if the initial state indicates a set of ingredients for a recipe, candidate templates identified by task optimization engine 116 may utilize a similar set of inputs. Task optimization engine 116 accesses one or more optimization criteria (e.g., received as user input at task management application 114), automatically determines the optimization criteria, or a combination thereof. For example, optimization criteria may be automatically determined based on an analysis of historical usage data associated with a given task template, task templates of a similar category, or task templates of a similar type, among other examples. As another example, a set of candidate optimization criteria is determined and presented to a user, thereby enabling the user to select one or more criteria from the set of candidates.

Accordingly, the candidate task templates are ranked based on the optimization criteria. For example, one or more costs associated with a candidate template are evaluated in view of optimization criteria to determine whether the optimization criteria are satisfied and, if so, to what degree. For example, candidate task templates are ranked based evaluating an associated cost in view of the optimization criteria (e.g., a monetary cost, an expected amount of time, etc.) or, in some instances, based on the extent to which the cost is above or below a threshold specified by the criteria. Depending on the criterion, the evaluation may depend on whether an associated cost is below a threshold (e.g., as may be the case with a budget or time constraint) or above a threshold (e.g., as may be the case with a number of people, a number of days spent traveling, etc.). In instances where multiple criteria are used, a set of weights may be used to evaluate each criterion and its associated cost.

As an example, a user indicates a set of optimization criteria comprising a monetary budget criterion and a time constraint criterion. The user may also indicate a higher importance for the time constraint criterion. Accordingly, a ranking metric is generated for each task template based on a lower weighting of the monetary cost and a higher weighting of the estimated time for each template. In other examples, the set of weights is determined to account for differences between different types of optimization criterion. For example, a monetary cost associated with a task may have higher variability as compared to estimated time of completion. Accordingly, the set of weights is generated based on the variability associated with each criterion, thereby enabling a better comparison between and ranking of candidate task templates.

In examples, the ranked list of candidate task templates is provided to task management application 114 for display to a user. In other examples, a task is automatically determined from the set of candidate task templates (e.g., based on selecting the highest ranked task, based on a user preference indication of a certain type of optimization and/or an associated threshold, such as favoring cost over time, etc.).

Task optimization engine 116 may also optimize one or more subtasks of an existing task in task management application 114. For example, an indication is received comprising a subtask and optimization criteria. Accordingly, task optimization engine 116 determines candidate subtasks to replace the received subtask. In examples, a set of subtasks is identified as a candidate to replace a single subtask or, in other examples, a single subtask is identified as a candidate to replace a set of subtasks. The candidate subtasks are ranked according to the optimization criteria. The ranked candidate subtasks may be provided to task management application 114 for display to a user. In other examples, a replacement subtask is automatically determined (e.g., based on selecting the highest ranked subtask, based on a user preference indication of a certain type of optimization and/or an associated threshold, such as favoring cost over time, etc.).

Task optimization engine 116 may access a remote task template catalog (e.g., as may be provided by server device 102) to perform the optimization techniques described herein. In another example, task optimization engine 116 evaluates subtasks of a task stored by task data store 118 in order to generate an optimized ordering of the subtasks. In some instances, historical information is stored by task data store 118 that relates to previous tasks and associated subtasks performed by a user. Thus, task optimization engine 116 may evaluate such stored historical information when identifying candidate tasks and/or replacement subtasks.

Client device 104 further comprises task data store 118. Task data store 118 stores task lists and associated tasks, as may be used by task management application 114 and task optimization engine 116. In examples, task data store 118 is stored locally to client device 104. In another example, at least a part of task data store 118 is stored remotely (e.g., by task data store 112 of server device 102), thereby enabling tasks to be synchronized among multiple devices.

Client device 106 comprises task management application 120, task optimization engine 122, and task data store 124, each of which are similar to task management application 114, task optimization engine 116, and task data store 118 of client device 104, respectively. In examples, client device 106 is a different type of computing device than client device 104. Additionally, it will be appreciated that client devices 104 and 106 may each be used by the same user or may be used by different users.

Server device 102 is illustrated as comprising request processing engine 108, task optimization engine 110, and task data store 112. In examples, request processing engine 108 processes task catalog requests and optimization requests, according to aspects described herein. Thus, in some examples, certain aspects of task optimization may be performed local to a client device (e.g., using task optimization engine 116 or 122), while other aspects are performed by task optimization engine 110 of server device 102. In other examples, a client device omits a local task optimization engine and uses task optimization engine 110 instead.

Server device 102 further comprises task optimization engine 110, which performs task and subtask optimization according to aspects described herein. Task optimization engine 110 performs similar functionality as discussed above with respect to task optimization engine 116. Therefore, certain aspects are not reiterated with respect to task optimization engine 110. In examples, task optimization engine 110 accesses data stored by task data store 112. For example, task data store 112 stores user-created task templates (e.g., as may be received from task management applications 114 and 120) and/or automatically generated task templates (e.g., as may be generated by a task template generator). For example, task optimization engine 110 analyzes task templates stored by task data store 112 to identify candidate task templates associated with a task goal. As another example, task optimization engine 110 identifies candidate replacement subtasks based on subtasks stored by task data store 112. In some examples, task data store 112 stores user account data comprising tasks and/or task lists (e.g., either as an alternative to or in combination with task data stores 118 and/or 124), thereby enabling cross-device synchronization and task backup capabilities.

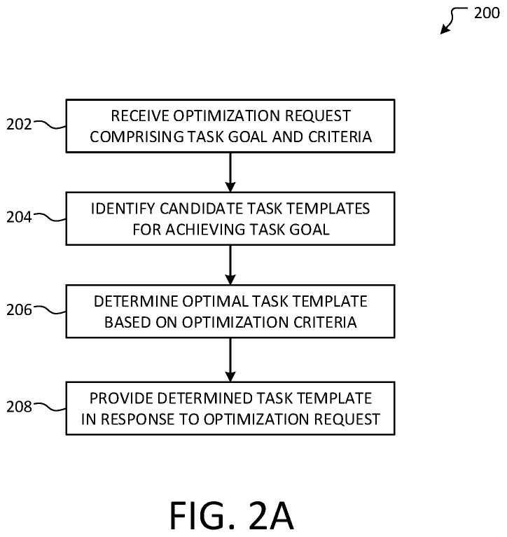

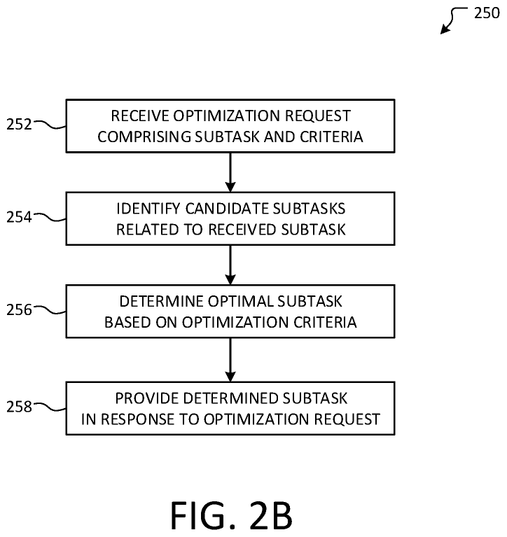

FIG. 2A illustrates an overview of an example method 200 for optimizing a task in response to an optimization request. In examples, aspects of method 200 are performed by a server, such as server device 102 in FIG. 1. Method 200 begins at operation 202, where an optimization request comprising a task goal and optimization criteria is received. In examples, the optimization request is received by a request processing engine, such as request processing engine 108 in FIG. 1. As used herein, a task goal indicates an end result or goal to achieve. For example, fixing a grill, preparing and delivering a presentation or other project, developing a software application, preparing a meal, or planning a trip, among other examples. The optimization criteria received as part of the optimization request may include a time constraint, a budget constraint, a dependency on the availability of another user (e.g., a specific user, a quantity of other people available for a task, etc.), and/or a dependence on another task, among other examples. In examples, the optimization criteria specify a threshold, while, in other examples, the optimization criteria more generally specify an improvement (e.g., a “faster” or “cheaper” way to achieve the task goal). In some examples, the optimization request further comprises an initial state or, in other examples, an initial state may be automatically determined for the user.

At operation 204, a set of candidate task templates for achieving the task goal are identified. In examples, generating the set of candidate task templates comprises evaluating one or more tags associated with a task template to determine whether it is related to the task goal. In other examples, a set of keywords, a title or description, and/or information associated with one or more subtasks are evaluated to determine task templates that are associated with the task goal. In examples, a pre-generated set of tasks is accessed based on the task goal. The task templates may be accessed from a task template data store, such as task data store 112 of server device 102 in FIG. 1. In examples where an initial state is received at operation 202, the determination may comprise an analysis of the initial state to identify task templates associated with a similar initial state. For example, if the initial state indicates a set of ingredients for a recipe, candidate templates identified by task optimization engine 116 may utilize a similar set of inputs. In some examples, aspects of operation 204 are performed by a task optimization engine, such as task optimization engine 110 in FIG. 1.

Flow progresses to operation 206, where an optimal task template is determined based on the optimization criteria received at operation 202. In some examples, determining an optimal task template comprises ranking the candidate task templates based on the optimization criteria. For example, one or more costs for each candidate template is evaluated in view of the optimization criteria to determine whether the optimization criteria are satisfied and, if so, to what degree. While method 200 is described with respect to receiving optimization criteria as part of the optimization request, it will be appreciated that, in other examples, at least a part of the optimization criteria may be automatically determined. In some examples, the highest-ranked task template is automatically determined to be the optimal task template. In other examples, a set of candidate task templates is determined as the optimal task template (e.g., based on a threshold, such as the top three, top five, candidate templates having a cost below the threshold, etc.), thereby enabling a user to manually select a task template from the set of templates.

At operation 208, the determined task template is provided in response to the optimization request received at operation 202. In examples, a set of ranked candidate task templates is provided as a list that is parsed by a client application, such as task management applications 114 or 120 in FIG. 1. In another example, the ranked task templates are provided as part of a web page, as may be processed by a web browser of a client device and presented to a user. In other instances, the determined optimal task template is provided in response, such that a task management application generates a task based on the task template. Aspects of method 208 may be performed by a request processing engine, such as request processing engine 108 of server device 102 in FIG. 1. Method 200 terminates at operation 208.

FIG. 2B illustrates an overview of an example method 250 for optimizing a subtask in response to an optimization request. In examples, aspects of method 250 are performed by a server, such as server device 102 in FIG. 1. Method 250 begins at operation 252, where an optimization request comprising a subtask and one or more optimization criteria is received. Example optimization criteria include, but are not limited to, a time constraint, a budget constraint, a dependency on the availability of another user, and/or a dependence on another task, among other example constraints. In examples, optimization criterion specifies a threshold, while, in other examples, optimization criterion may more generally specify an improvement (e.g., a “faster” or “cheaper” way to achieve the task goal). In some examples, the optimization request further comprises an indication as to the task that comprises the subtask (e.g., a task goal, a reference to the task itself or an associated task template, etc.). It will be appreciated that while method 250 is described with respect to determining an optimal subtask to replace a subtask, in other examples, an optimal set of subtasks may be determined. Similarly, multiple subtasks may be received and replaced by a single subtask.

At operation 254, a set of candidate subtasks relating to the received subtask are identified. In examples, generating the set of candidate subtasks comprises evaluating one or more tags associated with a task template to determine whether it is related to the subtask, and further identifying one or more relevant subtasks of the task template. In other examples, a set of keywords, a title or description, and/or information associated with the task templates is evaluated to identify subtasks that are relevant to the received subtask. In examples were a task goal, the task itself, or an associated task template is received, such information may be used as well. The task templates may be accessed from a task template data store, such as task data store 112 of server device 102 in FIG. 1. In some examples, aspects of operation 254 are performed by a task optimization engine, such as task optimization engine 110 in FIG. 1.

Moving to operation 256, an optimal subtask is determined based on the received optimization criteria. In some examples, determining an optimal subtask comprises ranking the candidate subtasks based on the optimization criteria. For example, one or more costs for each candidate subtask is evaluated in view of the optimization criteria to determine whether the optimization criteria is satisfied and, if so, to what degree. While method 250 is described with respect to receiving optimization criteria as part of the optimization request, it will be appreciated that, in other examples, at least a part of the optimization criteria may be automatically determined. In some examples, the highest-ranked subtask is automatically determined to be the optimal task template. In other examples, a set of candidate subtasks is determined as the optimal subtask (e.g., based on a threshold, such as the top three, top five, subtasks having a cost below the threshold, etc.), thereby enabling a user to manually select a subtask from the set of subtasks.

Flow progresses to operation 258, where the determined subtask is provided in response to the optimization request received at operation 252. In examples, a set of ranked subtasks is provided as a list that is parsed by a client application, such as task management applications 114 or 120 in FIG. 1. In another example, the ranked subtasks are provided as part of a web page, as may be processed by a web browser of a client device and presented to a user. In other instances, the determined optimal subtasks are provided in response, such that a task management application generates an updated task comprising the determined subtask. Aspects of method 258 may be performed by a request processing engine, such as request processing engine 108 of server device 102 in FIG. 1. Method 250 terminates at operation 258.

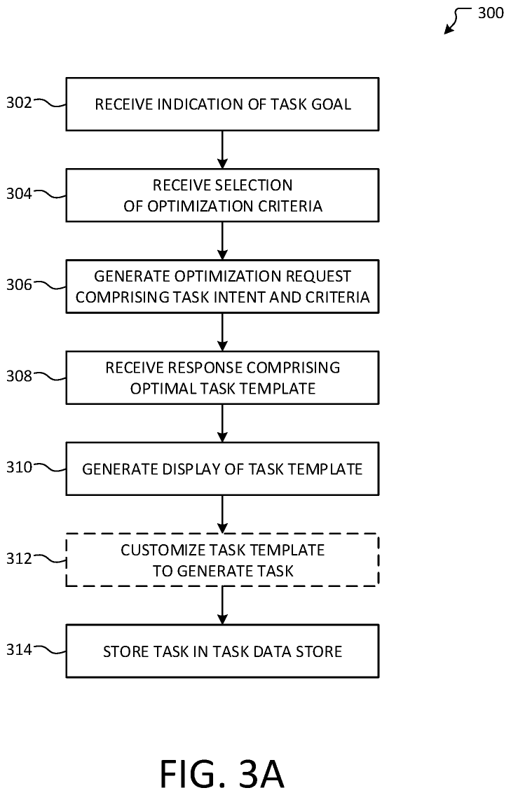

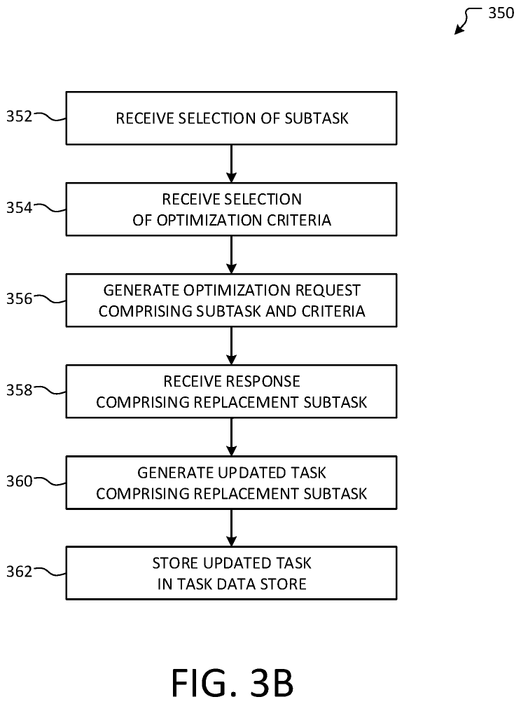

FIG. 3A illustrates an overview of an example method 300 for generating a task in a task management application based on optimization criteria. In examples, aspects of method 300 are performed by a client device, such as client device 104 or 106 in FIG. 1. Aspects of method 300 may be performed by a task management application. Method 300 begins at operation 302, where an indication of a task goal is received. The indication may be received as a result of user input or, in other examples, may be received automatically (e.g., as a result of a user taking an initial step toward the task goal, based on a determination that the user is performing a task that the user has previously performed, etc.). As described above, the task goal may indicate a desired end result or goal to achieve. In some examples, the task goal comprises text input by a user, a selection of a category or example task, or an automatically generated suggested task based on identified behavior, among other examples.

Flow progresses to operation 304, where a selection of optimization criteria is received. In examples, a user may input one or more thresholds associated with the criteria, select from a list of potential criteria (e.g., fastest, cheapest, etc.). In some examples, the user selects a single optimization criterion. While example criteria are described herein, it will be appreciated that any of a variety of criteria may be used. In some examples, a set of candidate optimization criteria is generated, from which the user selects the criteria received at operation 304. In other examples, aspects of operation 304 are omitted and optimization criteria is instead determined automatically according to aspects described herein. For example, a task is automatically optimized (e.g., as may be the case in instances where a user is unaware that the task can be optimized).

At operation 306, an optimization request is generated. In examples, the optimization request comprises the task goal and optimization criteria. It will be appreciated that, in other examples, the optimization request comprises an indication as to an initial state. For example, the initial state comprises information received from a user and/or determined from one or more computing devices.

Flow progresses to operation 308, where a response is received comprising an optimal task template. As discussed above, in some examples, a ranked list of multiple task templates is received. For example, the list may be in an Extensible Markup Language (XML) or JavaScript Object Notation (JSON) format that is parsed by an application (e.g., task management application 114 or 118 of client device 104 or 106 in FIG. 1, respectively). In another example, the optimal task template or set of task templates is received as part of a webpage. It will be appreciated that while example data formats are described herein, any of a variety of other techniques may be used.

Flow progresses to operation 310, where a display of the received task template is generated. For example, a task management application (e.g., task management application 114 or 118 of client device 104 or 106 in FIG. 1, respectively) generates a display of constituent subtasks of the optimal task template. It will be appreciated that one or more subtasks of the task template can be optimized according to aspects described herein, examples of which are discussed in more detail below with respect to method 350 of FIG. 3B. In examples, the display further comprises additional information relating to the task template, including why the task template was determined based on the optimization criteria, a description, and/or potential task template customizations that can be made to the task template. In examples where multiple task templates are received, a display comprising at least some of the task templates is generated, thereby enabling a user to determine which template to select. As another example, a web browser application is used to view the webpage received at operation 308. It will be appreciated that any of a variety of applications and display techniques may be used to present the task templates to a user.

At operation 312, the task template is customized to generate a task. Operation 312 is illustrated using a dashed box to indicate that, in some examples, operation 312 may be omitted. For example, if the task template does not offer any customizations, operation 312 may be omitted. In other examples, aspects of the task template are customized based on user input, device information, or any of a variety of other information that may be evaluated at operation 312. In some examples, aspects of the selected task template are left un-customized, such that they may be customized at a later time. For example, this may occur if the user is unsure of requested information or if information requested for the customization process is unavailable.

Flow progresses to operation 314, where the generated task is stored in a task data store. For example, the generated task may be stored in a task data store such as task data store 112, 118, or 124 of server device 102, client device 104, or client device 106 in FIG. 1, respectively. In some examples, the task is associated with a task list of the task management application. Flow terminates at operation 314.

FIG. 3B illustrates an overview of an example method 350 for optimizing a subtask based on optimization criteria. In examples, aspects of method 350 are performed by a client device, such as client device 104 or 106 in FIG. 1. Aspects of method 350 may be performed by a task management application. Method 350 begins at operation 352, where a selection of a subtask is received. As an example, a task management application displays a task and one or more of its constituent subtasks. A user may select one of the displayed subtasks as a subtask to be optimized. In some examples, according to aspects described herein, a selection of multiple subtasks is received.

At operation 354, a selection of optimization criteria is received. In examples, a user may input one or more thresholds associated with the criteria, select from a list of potential criteria (e.g., fastest, cheapest, etc.). In some examples, the user selects a single optimization criterion. While example criteria are described herein, it will be appreciated that any of a variety of criteria may be used. In some examples, a set of candidate optimization criteria is generated, from which the user selects the criteria received at operation 354. In other examples, aspects of operation 354 are omitted and optimization criteria is instead determined automatically according to aspects described herein. For example, a task is automatically optimized.

Moving to operation 356, an optimization request is generated. In examples, the optimization request comprises the selected subtask and selected optimization criteria. It will be appreciated that, in other examples, the optimization request comprises an indication as to the task with which the subtask is associated. For example, a reference to the task may be included or an indication of a task template associated with the task may be included, among other examples.

Flow progresses to operation 358, where a response is received comprising a replacement subtask. As discussed above, in some examples, a set of multiple subtasks is received. For example, the set may be in an XML or JSON format that is parsed by an application (e.g., task management application 114 or 118 of client device 104 or 106 in FIG. 1, respectively). In another example, the replacement subtask or set of subtasks is received as part of a webpage. It will be appreciated that while example data formats are described herein, any of a variety of other techniques may be used.

At operation 360, an updated task is generated comprising the replacement subtask. In examples, generating the updated task comprises replacing the selected subtask with the replacement subtask. In other examples, one or more subtasks of the task are rearranged in order to incorporate the replacement subtask. For example, the order of the subtasks may be determined by a task optimization engine. As discussed above, a set of multiple subtasks may be received to replace the selected subtask or, in other examples, one replacement subtask may replace a set of selected subtasks. Though method 350 is not illustrated as comprising the customization operation 312 discussed above with respect to method 300 in FIG. 3, it will be appreciated that such aspects may be incorporated into method 350 if the replacement subtask offers customizability.

Flow progresses to operation 314, where the generated task is stored in a task data store. For example, the generated task may be stored in a task data store such as task data store 112, 118, or 124 of server device 102, client device 104, or client device 106 in FIG. 1, respectively. In some examples, the task is associated with a task list of the task management application. Flow terminates at operation 314.

Moving to operation 362, the updated task is stored in a task data store. For example, the generated task may be stored in a task data store such as task data store 112, 118, or 124 of server device 102, client device 104, or client device 106 in FIG. 1, respectively. In some examples, the task is associated with a task list of the task management application. Flow terminates at operation 362.

While aspects of FIGS. 2A, 2B, 3A, and 3B are described in the context of a networked or distributed environment (e.g., between a client device and a server device), it will be appreciated that similar techniques may be used to implement aspects of the present application using a single computing device. Similarly, different operations may be performed by different computing devices in a networked or distributed environment.

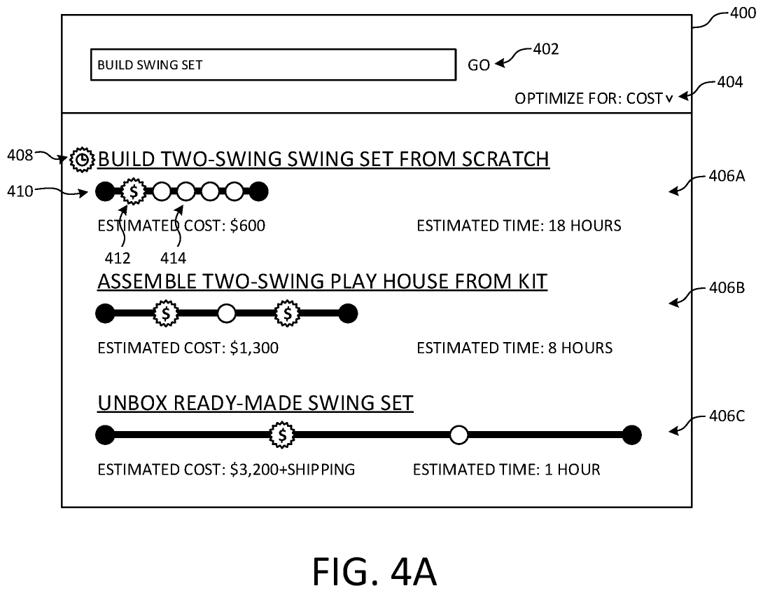

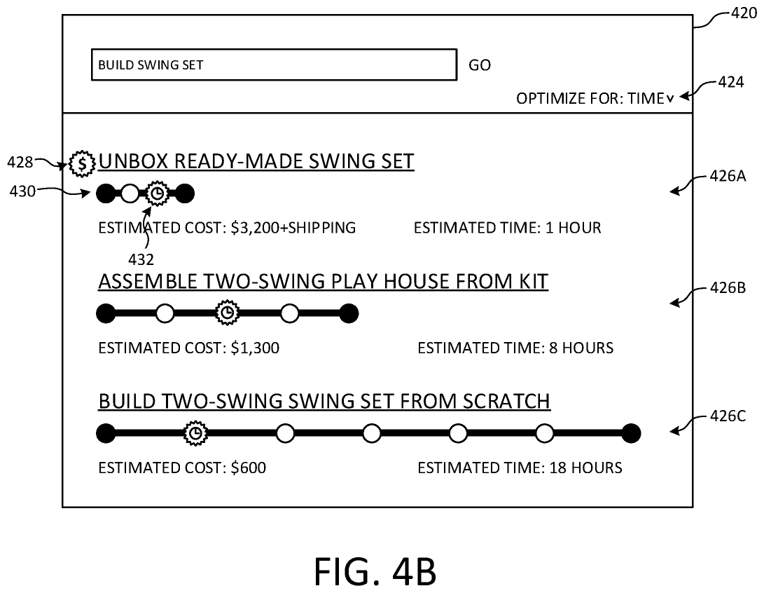

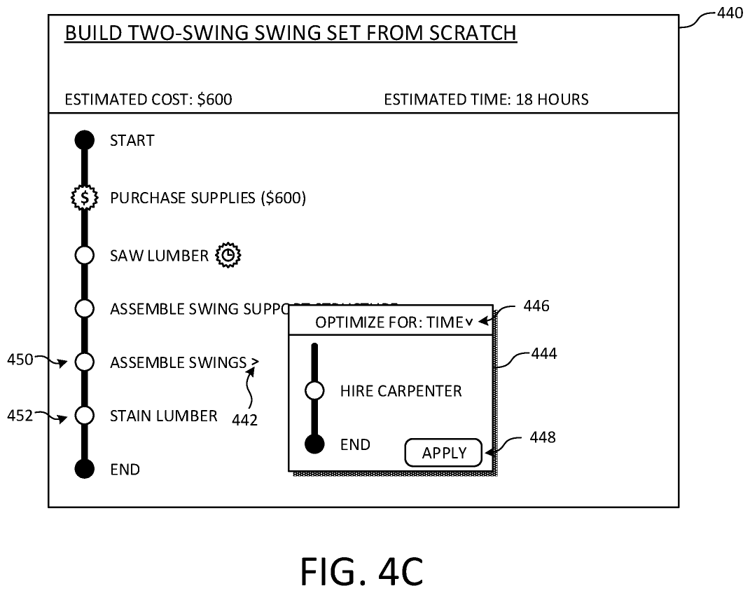

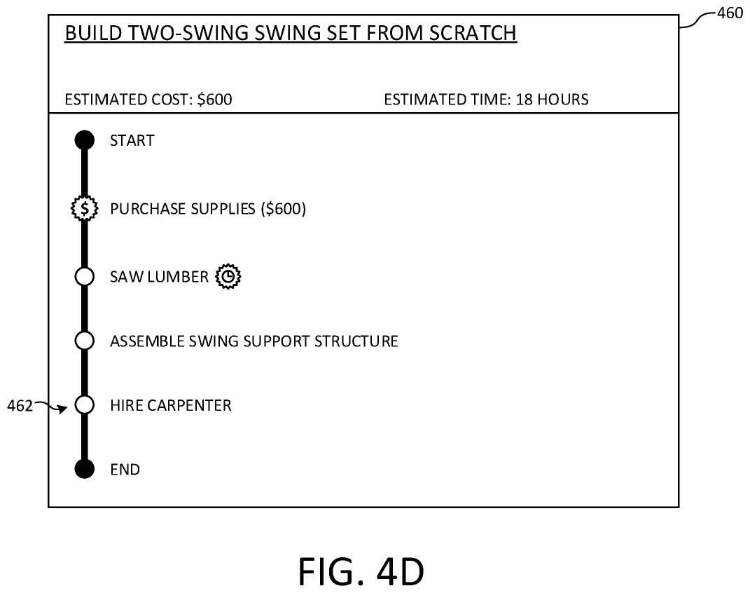

FIGS. 4A-4D illustrate overviews of example user interface features for task modification and optimization. In examples, user interface 400 illustrated in FIG. 4A is displayed by a client device, such as client device 104 or 106 in FIG. 1. As illustrated, user interface 400 comprises search box 402, optimization criteria selector 404, and results 406A-406C.

In examples, a user inputs a task goal into search box 402. Upon actuating the “GO” button illustrated as part of search box 402, an optimization request is generated. In examples, the optimization request is transmitted to a server device, such as server device 102, which is used to generate a set of candidate task templates. For example, aspects of method 200 discussed above with respect to FIG. 2A may be performed by the server device. In other examples, such aspects may be performed locally at the computing device. The candidate task templates are optimized according to the optimization criteria specified in optimization criteria selector 404. In other examples, a threshold value may be provided and/or multiple optimization criteria may be selected, among other examples. The set of candidate task templates is received and displayed in user interface 400.

As illustrated, results 406A-C are task templates that were identified to be relevant to the task goal in search box 402 and optimized accordingly. Results 406A-406C are illustrated as having a title (e.g., “BUILD TWO-SWING SWING SET FROM SCRATCH”), a timeline 410, and associated costs (e.g., “ESTIMATED COST: $600” and “ESTIMATED TIME:18 HOURS”). Further, the timeline for each respective result is scaled according to the attribute associated with the optimization criteria (e.g., cost). As illustrated, timeline 410 is shortest because it has the lowest cost of the displayed task templates. It will be appreciated that the task template listing illustrated by user interface 400 is provided as an example and that, in other examples, additional, alternative, or different information may be displayed.

User interface 400 is further illustrated as comprising time badge 408 to highlight a task template as having one or more subtasks that have a high time cost associated with them. In examples, a user may specify a filter to remove such task templates from the displayed results (e.g., altogether, based on a specified threshold, etc.). Similarly, a user preference may indicate a threshold above which such badges should be displayed. Further, the timelines associated with results 406A-406C comprise money badges, such as money badge 412. Such badges highlight certain subtasks having a high monetary cost (as compared to other subtasks of the task template, as compared to other displayed task templates, etc.). In examples, a user hovers, taps, or otherwise interacts with money badge 412 to determine which subtask is associated with the illustrated badge. Similar user experience aspects are applicable to element 414 as well. It will be appreciated that while example badges 408 and 412 are discussed herein, any of a variety of other badges may be used to indicate task templates with one or more notable subtasks.

FIG. 4B illustrates another view 420 of the user interface presented in FIG. 4A. Certain aspects depicted in FIG. 4B are described above in the context of FIG. 4A and, thus, are not necessarily described further. As compared to FIG. 4A, FIG. 4B illustrates the set of candidate task template results 426A-426C optimized according to time. Additionally, the timelines highlight different subtasks. For example, timeline 430 comprises time badge 432 to highlight a subtask that is comparatively time-intensive. Similar to timeline 410 in FIG. 4A, timeline 430 is scaled according to the time associated with the optimization criteria such that it is shortest because it has the lowest time of the displayed task templates. Money badge 428 indicates that result 426A is particularly costly. Thus, different subtasks may be highlighted depending on the optimization criteria specified by the user.

Turning now to FIG. 4C, task detail view 440 illustrates a view of a task as a result of a user selecting a task template from the displays discussed above with respect to FIGS. 4A and 4B. Specifically, task detail view 440 displays detail relating to result 406A/426C. Task detail view 440 depicts the subtasks associated with the task. As illustrated, arrow 442 enables a user to optimize a specific subtask of the illustrated task. In examples, an arrow is displayed when a user hovers, taps, or otherwise interacts with a subtask (as illustrated, arrow 442 is illustrated as a result of an interaction with subtask 450).

Optimization panel 444 is displayed once arrow 442 is actuated, which displays an optimization selector 446, which provides similar functionality to optimization criteria selectors 404 and 424 in FIGS. 4A and 4B, respectively. As described above, an optimization request is generated as a result of a user actuating arrow 442. The optimization request may comprise an indication as to the task and optimization criteria. Accordingly, a replacement subtask is displayed in optimization panel 444. Specifically, the replacement subtask is illustrated as a replacement to subtasks 450 and 452. When a user actuates apply button 448, an updated task is generated comprising the replacement subtask, which is illustrated in FIG. 4D as subtask 462.

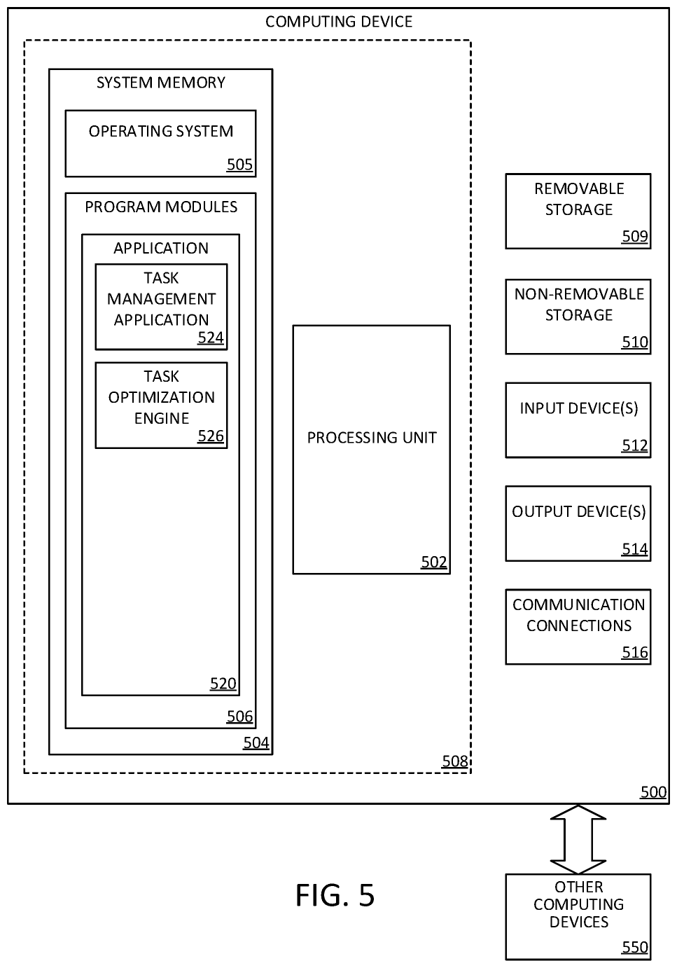

FIGS. 5-8 and the associated descriptions provide a discussion of a variety of operating environments in which aspects of the disclosure may be practiced. However, the devices and systems illustrated and discussed with respect to FIGS. 5-8 are for purposes of example and illustration and are not limiting of a vast number of computing device configurations that may be utilized for practicing aspects of the disclosure, described herein.

FIG. 5 is a block diagram illustrating physical components (e.g., hardware) of a computing device 500 with which aspects of the disclosure may be practiced. The computing device components described below may be suitable for the computing devices described above, including the computing devices 102, 104, and 106 in FIG. 1. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination of such memories.

The system memory 504 may include an operating system 505 and one or more program modules 506 suitable for running software application 520, such as one or more components supported by the systems described herein. As examples, system memory 504 may store task management application 524 and task optimization engine 526. The operating system 505, for example, may be suitable for controlling the operation of the computing device 500.

Furthermore, embodiments of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 (e.g., application 520) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 500 may also have one or more input device(s) 512 such as a keyboard, a mouse, a pen, a sound or voice input device, a touch or swipe input device, etc. The output device(s) 514 such as a display, speakers, a printer, etc. may also be included. The aforementioned devices are examples and others may be used. The computing device 500 may include one or more communication connections 516 allowing communications with other computing devices 550. Examples of suitable communication connections 516 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

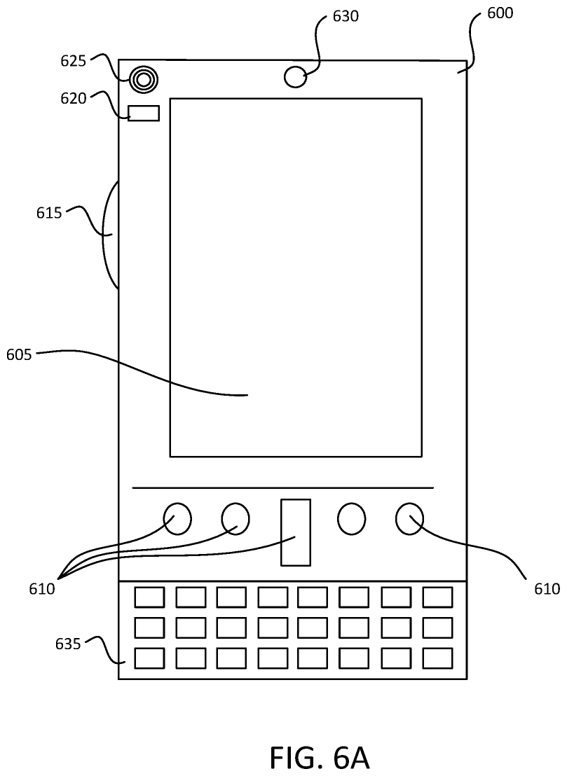

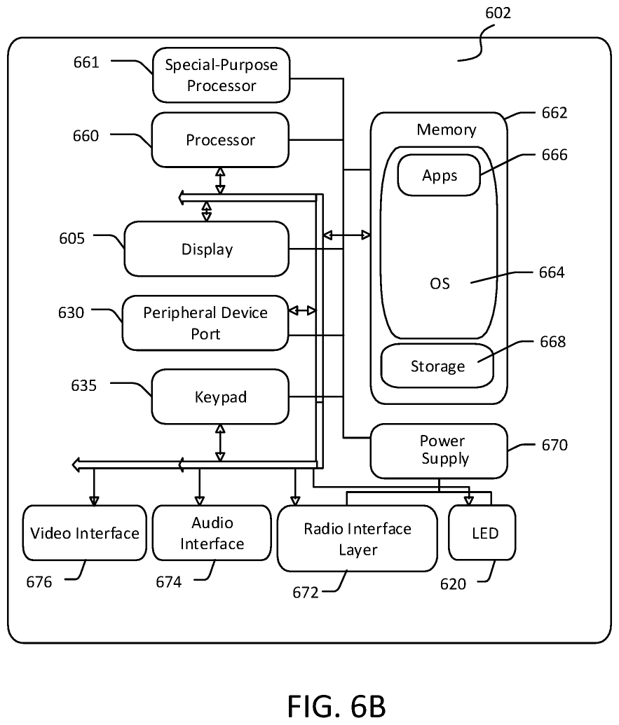

FIGS. 6A and 6B illustrate a mobile computing device 600, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 6A, one aspect of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display).

If included, an optional side input element 615 allows further user input. The side input element 615 may be a rotary switch, a button, or any other type of manual input element. In alternative aspects, mobile computing device 600 may incorporate more or less input elements. For example, the display 605 may not be a touch screen in some embodiments.

In yet another alternative embodiment, the mobile computing device 600 is a portable phone system, such as a cellular phone. The mobile computing device 600 may also include an optional keypad 635. Optional keypad 635 may be a physical keypad or a “soft” keypad generated on the touch screen display.

In various embodiments, the output elements include the display 605 for showing a graphical user interface (GUI), a visual indicator 620 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one aspect of a mobile computing device. That is, the mobile computing device 600 can incorporate a system (e.g., an architecture) 602 to implement some aspects. In one embodiment, the system 602 is implemented as a “smart phone” capable of running one or more applications (e.g., browser, e-mail, calendaring, contact managers, messaging clients, games, and media clients/players). In some aspects, the system 602 is integrated as a computing device, such as an integrated personal digital assistant (PDA) and wireless phone.

One or more application programs 666 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600 described herein (e.g., search engine, extractor module, relevancy ranking module, answer scoring module, etc.).

The system 602 has a power supply 670, which may be implemented as one or more batteries. The power supply 670 might further include an external power source, such as an AC adapter or a powered docking cradle that supplements or recharges the batteries.

The system 602 may also include a radio interface layer 672 that performs the function of transmitting and receiving radio frequency communications. The radio interface layer 672 facilitates wireless connectivity between the system 602 and the “outside world,” via a communications carrier or service provider. Transmissions to and from the radio interface layer 672 are conducted under control of the operating system 664. In other words, communications received by the radio interface layer 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated embodiment, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with embodiments of the present disclosure, the microphone may also serve as an audio sensor to facilitate control of notifications, as will be described below. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio interface layer 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio interface layer 672 or via a distributed computing network. Similarly, such data/information may be readily transferred between computing devices for storage and use according to well-known data/information transfer and storage means, including electronic mail and collaborative data/information sharing systems.

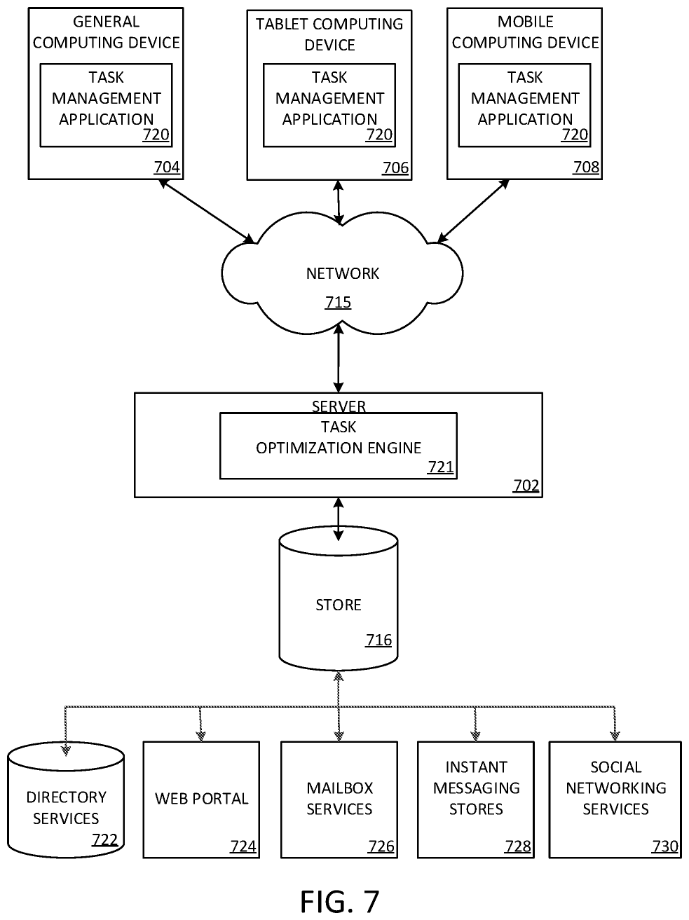

FIG. 7 illustrates one aspect of the architecture of a system for processing data received at a computing system from a remote source, such as a personal computer 704, tablet computing device 706, or mobile computing device 708, as described above. Content displayed at server device 702 may be stored in different communication channels or other storage types. For example, various documents may be stored using a directory service 722, a web portal 724, a mailbox service 726, an instant messaging store 728, or a social networking site 730.

A task management application 720 may be employed by a client that communicates with server device 702, and/or the task optimization engine 721 may be employed by server device 702. The server device 702 may provide data to and from a client computing device such as a personal computer 704, a tablet computing device 706 and/or a mobile computing device 708 (e.g., a smart phone) through a network 715. By way of example, the computer system described above may be embodied in a personal computer 704, a tablet computing device 706 and/or a mobile computing device 708 (e.g., a smart phone). Any of these embodiments of the computing devices may obtain content from the store 716, in addition to receiving graphical data useable to be either pre-processed at a graphic-originating system, or post-processed at a receiving computing system.

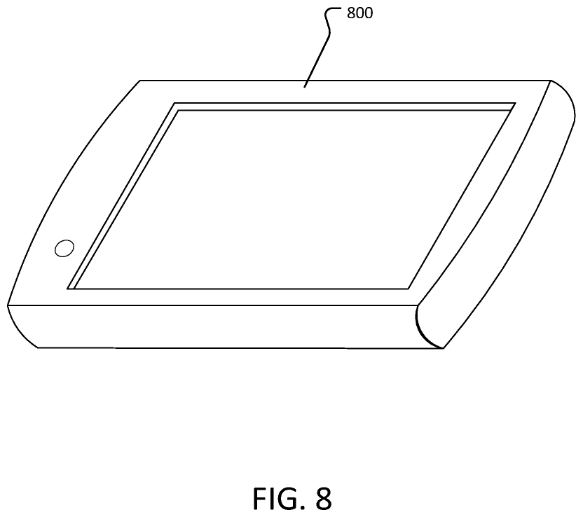

FIG. 8 illustrates an exemplary tablet computing device 800 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As will be understood from the foregoing disclosure, one aspect of the technology relates to a system comprising: at least one processor; and memory storing instructions that, when executed by the at least one processor, causes the system to perform a set of operations. The set of operations comprises: generating an optimization request comprising a task goal and at least one optimization criteria; receiving, in response to the optimization request, a set of candidate task templates associated with the task goal, the set of candidate task templates comprising at least a first task template; and generating a user interface comprising a first timeline associated with a first set of subtasks for the first task template. In an example, the set of candidate task templates further comprises a second task template; the user interface further comprises a second timeline associated with a second set of subtasks for the second task template; and the set of operations further comprises: receiving, at the user interface, a selection of either the first task template or the second task template; in response to the selection, generating a task based on the selected task template; and storing the generated task in a task data store. In another example, the first timeline comprises a badge that is at least one of a cost badge or a time badge. In a further example, the user interface further comprises an optimization criteria selector indicating the at least one optimization criteria. In yet another example, the optimization request further comprises an initial state relating to the task goal. In a further still example, information relating to a subtask of the first set of subtasks is displayed when an interaction is received by the first timeline. In an example, a first scale of the first timeline and a second scale of the second timeline are determined based on the at least one optimization criteria.

In another aspect, the technology relates to a method for optimizing a subtask of a task. The method comprises: receiving, at a user interface comprising a display of the task, a selection of the subtask; generating, in response to the selection, an optimization request comprising an indication of the subtask and an optimization criteria; receiving a response comprising a replacement subtask; generating a display of the replacement subtask; and based on receiving a user indication to replace the selected subtask with the replacement subtask, generating an updated task comprising the replacement subtask and omitting the selected subtask. In an example, the display of the replacement subtask further comprises an optimization selector indicating the optimization criteria. In another example, the method further comprises: updating the user interface to display the updated task comprising the replacement subtask; and storing the updated task in a task data store. In a further example, the optimization request further comprises information relating to the task. In yet another example, generating the updated task further comprises optimizing a set of subtasks comprising the replacement subtask. In a further still example, the response further comprises a second replacement subtask, and generating the display further comprises displaying the second replacement subtask.

In a further aspect, the technology relates to a method for optimizing a task. The method comprises: generating an optimization request comprising a task goal and at least one optimization criteria; receiving, in response to the optimization request, a set of candidate task templates associated with the task goal, the set of candidate task templates comprising at least a first task template; and generating a user interface comprising a first timeline associated with a first set of subtasks for the first task template. In an example, the set of candidate task templates further comprises a second task template, the user interface further comprises a second timeline associated with a second set of subtasks for the second task template, and the method further comprises: receiving, at the user interface, a selection of either the first task template or the second task template; in response to the selection, generating a task based on the selected task template; and storing the generated task in a task data store. In another example, the first timeline comprises a badge that is at least one of a cost badge or a time badge. In a further example, the user interface further comprises an optimization criteria selector indicating the at least one optimization criteria. In yet another example, the optimization request further comprises an initial state relating to the task goal. In a further still example, information relating to a subtask of the first set of subtasks is displayed when an interaction is received by the first timeline. In an example, a first scale of the first timeline and a second scale of the second timeline are determined based on the at least one optimization criteria.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
generating an optimization request comprising a task goal and at least one optimization criteria;
receiving, in response to the optimization request, a set of candidate task templates associated with the task goal, the set of candidate task templates comprising at least a first task template; and
generating a user interface comprising a first timeline associated with a first set of subtasks for the first task template.

2. The system of claim 1, wherein:
the set of candidate task templates further comprises a second task template;
the user interface further comprises a second timeline associated with a second set of subtasks for the second task template; and
the set of operations further comprises:
receiving, at the user interface, a selection of either the first task template or the second task template;
in response to the selection, generating a task based on the selected task template; and
storing the generated task in a task data store.

3. The system of claim 1, wherein the first timeline comprises a badge that is at least one of a cost badge or a time badge.

4. The system of claim 1, wherein the user interface further comprises an optimization criteria selector indicating the at least one optimization criteria.

5. The system of claim 1, wherein the optimization request further comprises an initial state relating to the task goal.

6. The system of claim 1, wherein information relating to a subtask of the first set of subtasks is displayed when an interaction is received by the first timeline.

7. The system of claim 2, wherein a first scale of the first timeline and a second scale of the second timeline are determined based on the at least one optimization criteria.

8. A method for optimizing a subtask of a task, comprising:
receiving, at a user interface comprising a display of the task, a selection of the subtask;
generating, in response to the selection, an optimization request comprising an indication of the subtask and an optimization criteria;
receiving a response comprising a replacement subtask;
generating a display of the replacement subtask; and
based on receiving a user indication to replace the selected subtask with the replacement subtask, generating an updated task comprising the replacement subtask and omitting the selected subtask.

9. The method of claim 8, wherein the display of the replacement subtask further comprises an optimization selector indicating the optimization criteria.

10. The method of claim 8, further comprising:
updating the user interface to display the updated task comprising the replacement subtask; and
storing the updated task in a task data store.

11. The method of claim 8, wherein the optimization request further comprises information relating to the task.

12. The method of claim 8, wherein generating the updated task further comprises optimizing a set of subtasks comprising the replacement subtask.

13. The method of claim 8, wherein the response further comprises a second replacement subtask, and generating the display further comprises displaying the second replacement subtask.

14. A method for optimizing a task, comprising:
generating an optimization request comprising a task goal and at least one optimization criteria;
receiving, in response to the optimization request, a set of candidate task templates associated with the task goal, the set of candidate task templates comprising at least a first task template; and
generating a user interface comprising a first timeline associated with a first set of subtasks for the first task template.

15. The method of claim 14, wherein the set of candidate task templates further comprises a second task template, wherein the user interface further comprises a second timeline associated with a second set of subtasks for the second task template, and wherein the method further comprises:
receiving, at the user interface, a selection of either the first task template or the second task template;
in response to the selection, generating a task based on the selected task template; and
storing the generated task in a task data store.

16. The method of claim 14, wherein the first timeline comprises a badge that is at least one of a cost badge or a time badge.

17. The method of claim 14, wherein the user interface further comprises an optimization criteria selector indicating the at least one optimization criteria.

18. The method of claim 14, wherein the optimization request further comprises an initial state relating to the task goal.

19. The method of claim 14, wherein information relating to a subtask of the first set of subtasks is displayed when an interaction is received by the first timeline.

20. The method of claim 15, wherein a first scale of the first timeline and a second scale of the second timeline are determined based on the at least one optimization criteria.
